(19) United States
(12) Patent Application Publication
(10) Pub. No.: US 2024/0294740 A1
(43) Pub. Date: Sep. 5, 2024

(54) THERMOSET ARTICLES COMPRISING NITRILE BUTADIENE RUBBER

(71) Applicant: Avient Corporation, Avon Lake, OH (US)

(72) Inventors: Jiren GU, Crystal Lake, IL (US); Hochul JUNG, Algonquin, IL (US); John SWANSON, Lakewood, OH (US)

(73) Assignee: Avient Corporation, Avon Lake, OH (US)

(21) Appl. No.: 18/572,176

(22) PCT Filed: Jun. 29, 2022
(86) PCT No.: PCT/US2022/035518

§ 371 Date: Dec. 19, 2023

Related U.S. Application Data
(60) Provisional application No. 63/216,863, filed on Jun. 30, 2021.

(51) Int. Cl. C08L 9/02; C08C 19/25; C08J 3/24; C08L 23/08

(52) U.S. Cl. CPC C08L 9/02; C08C 19/25; C08J 3/24; C08L 23/0815; C08J 2309/02; C08J 2323/08; C08J 2409/02; C08J 2423/08; C08J 2423/12; C08L 2312/08

(57) ABSTRACT

Embodiments of the present disclosure are directed to thermoset articles including a crosslinked reaction product of thermoplastic polyolefin, at least one of ethylene alpha-olefin polyolefin elastomer and ethylene propylene diene rubber, nitrile butadiene rubber, and silane. At least one of the thermoplastic polyolefin, the at least one of the ethylene alpha-olefin polyolefin elastomer and the ethylene propylene diene rubber, and the nitrile butadiene rubber is silane grafted and silane crosslinked. The silane crosslinking is at least one of intramolecular silane crosslinking and intermolecular silane crosslinking.

### CLAIM OF PRIORITY

This application claims the benefit of U.S. Provisional Patent Application Ser. No. 63/216,863 bearing Attorney Docket Number 1202106 and filed on Jun. 30, 2021, which is hereby incorporated by reference in its entirety.

### TECHNICAL FIELD

Embodiments of the present disclosure are generally related to thermoset articles, and are specifically related to thermoset articles of thermoplastic polyolefin, at least one of ethylene alpha-olefin polyolefin elastomer and ethylene propylene diene rubber, and nitrile butadiene rubber having improved oil resistance.

### BACKGROUND

Thermoset articles including silane crosslinked blends of polyolefin elastomer may have desirable mechanical properties, such as tensile strength at break and tensile elongation at break. However, these articles may not have the chemical resistance (e.g., oil resistance) necessary for certain applications in the healthcare, automotive, industrial, and electronic fields.

Accordingly, a continual need exists for improved thermoset articles that have improved oil resistance for the aforementioned applications.

### SUMMARY

Embodiments of the present disclosure are directed to thermoset articles comprising a crosslinked reaction product of thermoplastic polyolefin, at least one of ethylene alpha-olefin polyolefin elastomer and ethylene propylene diene rubber, nitrile butadiene rubber, and silane, which provide improved oil resistance.

According to one embodiment, a thermoset article is provided. The thermoset article comprises the crosslinked reaction product of thermoplastic polyolefin, at least one of ethylene alpha-olefin polyolefin elastomer and ethylene propylene diene rubber, nitrile butadiene rubber, and silane. At least one of the thermoplastic polyolefin, the at least one of the ethylene alpha-olefin polyolefin elastomer and the ethylene propylene diene rubber, and the nitrile butadiene rubber is silane grafted and silane crosslinked. The silane crosslinking is at least one of intramolecular silane crosslinking and intermolecular silane crosslinking

Additional features and advantages of the embodiments described herein will be set forth in the detailed description which follows, and in part will be readily apparent to those skilled in the art from that description or recognized by practicing the embodiments described herein, including the detailed description, which follows and the claims.

### DETAILED DESCRIPTION

Reference will now be made in detail to various embodiments of thermoset articles, specifically thermoset articles comprising the crosslinked reaction product of thermoplastic polyolefin, at least one of ethylene alpha-olefin polyolefin elastomer and ethylene propylene diene rubber, nitrile butadiene rubber, and silane. At least one of the thermoplastic polyolefin, the at least one of the ethylene alpha-olefin polyolefin elastomer and the ethylene propylene diene rubber, and the nitrile butadiene rubber is silane grafted and silane crosslinked. The silane crosslinking is at least one of intramolecular silane crosslinking and intermolecular silane crosslinking.

The disclosure should not be construed as limited to the embodiments set forth herein. Rather, these embodiments are provided so that this disclosure will be thorough and complete, and will fully convey the subject matter to those skilled in the art.

### Definitions

Unless otherwise defined, all technical and scientific terms used herein have the same meaning as commonly understood by one of ordinary skill in the art. The terminology used in the disclosure herein is for describing particular embodiments only and is not intended to be limiting.

Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used in the specification and the appended claims, the singular forms “a,” “an,” and “the” are intended to include the plural forms as well, unless the context clearly indicates otherwise. Thus, for example, reference to “a” component includes aspects having two or more such components, unless the context clearly indicates otherwise.

The term “wt %,” as described herein, refers to the weight fraction of the individual reactants of the formulation used to produce the crosslinked reaction product that comprises the thermoset article, unless otherwise noted. For simplicity purposes, “wt %” will be referred to throughout as the amount in the thermoset article.

The term “melt flow rate,” as described herein, refers to the ability of a material's melt to flow under pressure as measured according to ASTM D1238 at the given temperature and given weight.

The term “density,” as described herein, refers to the mass per unit volume of a material as measured according to ASTM D792 at 23° C.

The term “specific gravity,” as described herein, refers to the ratio of the density of a material to the density of water as measured according to ASTM D792 at 23° C.

The term “Mooney viscosity,” as described herein, refers to the viscosity reached after a rotor rotates for a given time interval at the specified temperature as measured according to ASTM D1646.

The term “yield,” as described herein, refers to the point on a stress-strain curve that indicates the limit of elastic behavior and the beginning of plastic behavior.

The term “tensile strength at yield,” as described herein, refers to the maximum stress that a material can withstand while being stretched before it begins to change shape permanently as measured according to ASTM D638 at 23° C. and a rate of strain of 0.85 mm/s.

The term “tensile elongation at yield,” as described herein, refers to the ratio between the increased length and initial length at the yield point as measured according to ASTM D638 at 23° C. and a rate of strain of 0.85 mm/s.

The term “tensile strength at break,” as described herein, refers to the maximum stress that a material can withstand while stretching before breaking as measured according to ASTM D638 at 23° C. and a rate of strain of 0.85 mm/s.

The term “tensile elongation at break,” as described herein, refers to the ratio between increased length and initial length after breakage as measured according to ASTM D638 at 23° C. and a rate of strain of 0.85 mm/s.

The term “Shore A hardness,” as described herein, refers to the hardness of a material as measured according to ASTM D2240.

The term “melting point,” as described herein, is measured using differential scanning calorimetry (DSC).

The term “thermoset article,” as described herein, refers to an article including crosslinking that is irreversible such that the article cannot successfully be remolded or reheated after initial heat-forming or molding.

The term “silane grafted,” as described herein, refers to the thermoplastic polyolefin, the ethylene alpha-olefin polyolefin elastomer, the ethylene propylene diene rubber, or the nitrile butadiene rubber having a silane side chain connected to the polymer main chain. The grafted silane allow the thermoplastic polyolefin, the ethylene alpha-olefin polyolefin elastomer, the ethylene propylene diene rubber, or the nitrile butadiene rubber to intramolecular silane crosslink or intermolecular silane crosslink.

The term “intramolecular silane crosslinking,” as described herein, refers to silane crosslinking that occurs when the thermoplastic polyolefin, the ethylene alpha-olefin polyolefin elastomer, the ethylene propylene diene rubber, or the nitrile butadiene rubber crosslinks with itself.

The term “intermolecular silane crosslinking,” as described herein, refers to silane crosslinking that occurs when the thermoplastic polyolefin, the ethylene alpha-olefin polyolefin elastomer, the ethylene propylene diene rubber, or the nitrile butadiene rubber crosslinks with another of the thermoplastic polyolefin, the ethylene alpha-olefin polyolefin elastomer, the ethylene propylene diene rubber, or the nitrile butadiene rubber.

The term “ethylene propylene diene rubber,” as described herein, may be used interchangeably with “ethylene propylene diene polymer.”

The term “copolymer,” as described herein, refers to a polymer formed when two or more monomers are linked in the same chain.

The term “thermoplastic polyolefin,” as described herein, refers to a high crystalline (i.e., greater than or equal to 40% crystalline) blend including a thermoplastic domain, an amorphous elastomer or rubber domain, and optionally a filler.

The term “polyolefin elastomer,” as described herein, refers to a low crystalline (i.e., less than or equal to 25% crystalline) blend including a thermoplastic domain, an amphorous elastomer or rubber domain, and optionally a filler.

As discussed hereinabove, thermoset articles including silane crosslinked blends of polyolefin (e.g., polypropylene) may have desirable mechanical properties, such as tensile strength at break and tensile elongation at break. However, these articles may not have the chemical resistance (e.g., oil resistance) necessary for certain applications in the healthcare, automotive, industrial, and electronic fields.

Disclosed herein are thermoset articles, which mitigate the aforementioned problems. Specifically, the oil resistant thermoset articles disclosed herein comprise a crosslinked reaction product of: thermoplastic polyolefin; at least one of ethylene alpha-olefin polyolefin elastomer and ethylene propylene diene rubber; nitrile butadiene rubber; and silane. At least one of the thermoplastic polyolefin, the ethylene alpha-olefin polyolefin elastomer, the ethylene propylene diene rubber, and the nitrile butadiene rubber is silane grafted and silane crosslinked. The silane crosslinking is at least one of intramolecular silane crosslinking and intermolecular crosslinking. This occurrence of silane crosslinking, along with the specific amounts of thermoplastic polyolefin, at least one of ethylene alpha-olefin polyolefin elastomer and ethylene propylene diene rubber, and nitrile butadiene rubber, produces a thermoset article having improved oil resistance.

The thermoset articles disclosed herein may generally be described as the crosslinked reaction product of: thermoplastic polyolefin; at least one of ethylene alpha-olefin polyolefin elastomer and ethylene propylene diene rubber; nitrile butadiene rubber; and silane.

### Thermoplastic Polyolefin

As described hereinabove, the presence and specific amount of thermoplastic polyolefin, along with at least one of ethylene alpha-olefin polyolefin elastomer and ethylene propylene diene rubber and nitrile butadiene rubber, produces a thermoset article having improved oil resistance.

Various thermoplastic polyolefins are considered suitable for the present thermoset articles. In embodiments, the thermoplastic polyolefin may comprise polypropylene, polyethylene, or a combination thereof.

In embodiments, the polypropylene may comprise a polypropylene homopolymer (i.e., composed of propylene monomers) or a polypropylene copolymer having greater than 50 wt % propylene monomer and an additional comonomer such as C₂ and C₄-C₁₂ alpha olefins.

In embodiments, the polyethylene may comprise a polyethylene homopolymer (i.e., composed of ethylene monomers) or a polyethylene copolymer having greater than 50 wt % ethylene monomer and an additional comonomer, such as C₃-C₁₂ alpha olefins.

In embodiments, the thermoplastic polyolefin is at least one of high density polyethylene (e.g., greater than or equal to 0.940 g/cm³) or a crystalline polypropylene with a percent crystallinity of at least about 60%.

In embodiments, the thermoplastic polyolefin is included in amounts greater than 5 wt %. In embodiments, the amount of thermoplastic polyolefin may be limited (e.g., less than or equal to 20 wt %). In embodiments, the amount of thermoplastic polyolefin in the thermoset article may be greater than or equal to 5 wt %, greater than or equal to 6 wt %, greater than or equal to 7 wt %, greater than or equal to 8 wt %, or even greater than or equal to 9 wt %. In embodiments, the amount of thermoplastic polyolefin in the thermoset article may be less than or equal to 20 wt %, less than or equal to 19 wt %, less than or equal to 18 wt %, less than or equal to 17 wt %, or even less than or equal to 16 wt %. In embodiments, the amount of thermoplastic polyolefin in the thermoset article may be from 5 wt % to 20 wt %, from 5 wt % to 19 wt %, from 5 wt % to 18 wt %, from 5 wt % to 17 wt %, from 5 wt % to 16 wt %, from 6 wt % to 20 wt %, from 6 wt % to 19 wt %, from 6 wt % to 18 wt %, from 6 wt % to 17 wt %, from 6 wt % to 16 wt %, from 7 wt % to 20 wt %, from 7 wt % to 19 wt %, from 7 wt % to 18 wt %, from 7 wt % to 17 wt %, from 7 wt % to 16 wt %, from 8 wt % to 20 wt %, from 8 wt % to 19 wt %, from 8 wt % to 18 wt %, from 8 wt % to 17 wt %, from 8 wt % to 16 wt %, from 9 wt % to 20 wt %, from 9 wt % to 19 wt %, from 9 wt % to 18 wt %, from 9 wt % to 17 wt %, or even from 9 wt % to 16 wt %, or any and all sub-ranges formed from any of these endpoints.

In embodiments, the polypropylene may comprise a melt flow rate (230° C./2.16 kg) greater than or equal to 0.1 g/10 min, greater than or equal to 0.5 g/10 min, greater than or equal to 1 g/10 min or even greater than or equal to 3 g/10 min. In embodiments, the polypropylene may comprise a melt flow rate (230° C./2.16 kg) less than or equal to 10 g/10 min or even less than or equal to 5 g/10 min. In embodiments, the polypropylene may comprise a melt flow rate (230° C./2.16 kg) from 0.1 g/10 min to 10 g/10 min, from 0.1 g/10 min to 5 g/10 min, from 0.5 g/10 min to 10 g/10 min, from 0.5 g/10 min to 5 g/10 min, from 1 g/10 min to 10 g/10 min, from 1 g/10 min to 5 g/10 min, from 3 g/10 min to 10 g/10 min, or even from 3 g/10 min to 5 g/10 min, or any and all sub-ranges formed from any of these endpoints.

In embodiments, the thermoplastic polyolefin may comprise a density greater than or equal to 0.8 g/cm³ or even greater than or equal to 0.85 g/cm³. In embodiments, the thermoplastic polyolefin may comprise a density less than or equal to 1.10 g/cm³ or even less than or equal to 1.00 g/cm³. In embodiments, the thermoplastic polyolefin may comprise a density from 0.80 g/cm³ to 1.10 g/cm³, from 0.80 g/cm³ to 1.00 g/cm³, from 0.85 g/cm³ to 1.10 g/cm³, or even from 0.85 g/cm³ to 1.00 g/cm³, or any and all sub-ranges formed from any of these endpoints.

In embodiments, the thermoplastic polyolefin may have a melting point greater than or equal to 100° C., greater than or equal to 110° C., or even greater than or equal to 120° C.

In embodiments, the thermoplastic polyolefin may comprise a tensile strength at yield greater than or equal to 25 MPa or even greater than or equal to 30 MPa. In embodiments, the thermoplastic polyolefin may comprise a tensile strength at yield less than or equal to 45 MPa or even less than or equal to 40 MPa. In embodiments, the thermoplastic polyolefin may comprise a tensile strength at yield from 25 MPa to 45 MPa, from 25 MPa, to 40 MPa, from 30 MPa to 45 MPa, or even from 30 MPa to 40 MPa, or any and all sub-ranges formed from any of these endpoints.

In embodiments, the thermoplastic polyolefin may comprise a tensile elongation at yield greater than or equal to 3% or even greater than or equal to 5%. In embodiments, the thermoplastic polyolefin may comprise a tensile elongation at yield less than or equal to 20% or even less than or equal to 15%. In embodiments, the thermoplastic polyolefin may comprise a tensile elongation at yield from 3% to 20%, from 3% to 15%, from 5% to 20%, or even from 5% to 15%, or any and all sub-ranges formed from any of these endpoints.

Suitable commercial embodiments of the thermoplastic polyolefin are available under the FORMOLENE brand from Formosa Plastics, such as polypropylene homopolymer grade 1102KR. Table 1 shows certain properties of FORMOLENE 1102KR.

TABLE 1

| | FORMOLENE 1102KR |
|---|---|
| Melt flow rate (230° C./2.16 kg) (g/10 min) | 4 |
| Density (g/cm³) | 0.9 |
| Tensile strength at yield (MPa) | 36 |
| Tensile elongation at yield (%) | 9 |

### Ethylene Alpha-olefin Polyolefin Elastomer and Ethylene Propylene Diene Rubber

As described hereinabove, the presence and specific amount of at least one of ethylene alpha-olefin polyolefin elastomer and ethylene propylene diene rubber, along with thermoplastic polyolefin and nitrile butadiene rubber, produces a thermoset article having improved oil resistance.

The ethylene alpha-olefin is the polymerized reaction product of ethylene and C₃-C₁₂ olefins. For example, in embodiments, the ethylene alpha-olefin copolymer may comprise ethylene-octene copolymer, ethylene-hexene copolymer, ethylene-butene copolymer, or a combination thereof.

The ethylene propylene diene rubber is the polymerized reaction product of ethylene, propylene, and diene. The ethylene propylene diene rubber may comprise one or more of ethylidene norbornene, dicyclopentadiene, and vinyl norbornene.

In embodiments, the ethylene alpha-olefin polyolefin elastomer and/or the ethylene propylene diene rubber is included in amounts greater than or equal to 20 wt %. In embodiments, the amount of the ethylene alpha-olefin polyolefin elastomer and/or the ethylene propylene diene rubber may be limited (e.g., less than or equal to 60 wt %). In embodiments, the amount of the ethylene alpha-olefin polyolefin elastomer and/or the ethylene propylene diene rubber in the thermoset article may be greater than or equal to 20 wt %, greater than or equal to 23 wt %, greater than or equal to 25 wt %, or even greater than or equal to 27 wt %. In embodiments, the amount of the ethylene alpha-olefin polyolefin elastomer and/or the ethylene propylene diene rubber in the thermoset article may be less than or equal to 70 wt %, less than or equal to 65 wt %, less than or equal to 60 wt %, less than or equal to 55 wt %, less than or equal to 50 wt %, less than or equal to 45 wt %, less than or equal to 43 wt %, or even less than or equal to 41 wt %. In embodiments, the amount of ethylene alpha-olefin polyolefin elastomer and/or the ethylene propylene diene rubber in the thermoset article may be from 20 wt % to 70 wt %, 20 wt % to 65 wt %, from 20 wt % to 60 wt %, from 20 wt % to 55 wt %, from 20 wt % to 50 wt %, from 20 wt % to 45 wt %, from 20 wt % to 43 wt %, from 20 wt % to 41 wt %, from 23 wt % to 70 wt %, 23 wt % to 65 wt %, from 23 wt % to 60 wt %, from 23 wt % to 55 wt %, from 23 wt % to 50 wt %, from 23 wt % to 45 wt %, from 23 wt % to 43 wt %, from 23 wt % to 41 wt %, from 25 wt % to 70 wt %, 25 wt % to 65 wt %, from 25 wt % to 60 wt %, from 25 wt % to 55 wt %, from 25 wt % to 50 wt %, from 25 wt % to 45 wt %, from 25 wt % to 43 wt %, from 25 wt % to 41 wt %, from 27 wt % to 70 wt %, 27 wt % to 65 wt %, from 27 wt % to 60 wt %, from 27 wt % to 55 wt %, from 27 wt % to 50 wt %, from 27 wt % to 45 wt %, from 27 wt % to 43 wt %, or even from 27 wt % to 41 wt %, or any and all sub-ranges formed from any of these endpoints.

In embodiments, the ethylene alpha-olefin polyolefin elastomer and/or the ethylene propylene diene rubber may comprise a melt flow rate (190° C./2.16 kg) greater than or equal to 0.1 g/10 min or even greater than or equal to 0.25 g/10 min. In embodiments, the ethylene alpha-olefin polyolefin elastomer and/or the ethylene propylene diene rubber may comprise a melt flow rate (190° C./2.16 kg) less than or equal to 3 g/10 min or even less than or equal to 1 g/10 min. In embodiments, the ethylene alpha-olefin polyolefin elastomer and/or the ethylene propylene diene rubber may comprise a melt flow rate (190° C./2.16 kg) from 0.1 g/10 min to 3 g/10 min, from 0.1 g/10 min to 1 g/10 min, from 0.25 g/10 min to 3 g/10 min, or even from 0.25 g/10 min to 1 g/10 min, or any and all sub-ranges formed from any of these endpoints.

In embodiments, the ethylene alpha-olefin polyolefin elastomer and/or the ethylene propylene diene rubber may comprise a density greater than or equal to 0.80 g/cm³ or even greater than or equal to 0.85 g/cm³. In embodiments, the ethylene alpha-olefin polyolefin elastomer and/or the ethylene propylene diene rubber may comprise a density less than or equal to 0.95 g/cm³ or even less than or equal to 0.90 g/cm³. In embodiments, the ethylene alpha-olefin polyolefin elastomer and/or the ethylene propylene diene rubber may comprise a density from 0.80 g/cm³ to 0.95 g/cm³, from 0.80 g/cm³ to 0.90 g/cm³, from 0.85 g/cm³ to 0.95 g/cm³, or even from 0.85 g/cm³ to 0.90 g/cm³, or any and all sub-ranges formed from any of these endpoints.

In embodiments, the ethylene alpha-olefin polyolefin elastomer and/or the ethylene propylene diene rubber may comprise a Mooney viscosity (ML 1+4, 125° C.) greater than or equal to 30, greater than or equal to 50, or even greater than or equal to 70. In embodiments, the ethylene alpha-olefin polyolefin elastomer and/or the ethylene propylene diene rubber may have a Mooney viscosity (ML 1+4, 125° C.) less than or equal to 150, less than or equal to 125, or even less than or equal to 100. In embodiments, the ethylene alpha-olefin polyolefin elastomer and/or the ethylene propylene diene rubber may comprise a Mooney viscosity (ML 1+4, 125° C.) from 30 to 150, from 30 to 125, from 30 to 100, from 50 to 150, from 50 to 125, from 50 to 100, from 70 to 150, from 70 to 125, or even from 70 to 100, or any and all sub-ranges formed from any of these endpoints.

In embodiments, the ethylene alpha-olefin polyolefin elastomer and/or the ethylene propylene diene rubber may comprise a tensile strength at break greater than or equal to 1 MPa or even greater than or equal to 2 MPa. In embodiments, the ethylene alpha-olefin polyolefin elastomer and/or the ethylene propylene diene rubber may comprise a tensile strength at break less than or equal to 10 MPa or even less than or equal to 5 MPa. In embodiments, the ethylene alpha-olefin polyolefin elastomer and/or the ethylene propylene diene rubber may comprise a tensile strength at break from 1 MPa to 10 MPa, from 1 MPa to 5 MPa, from 2 MPa to 10 MPa, or even from 2 MPa to 5 MPa, or any and all sub-ranges formed from any of these endpoints.

In embodiments, the ethylene alpha-olefin polyolefin elastomer and/or the ethylene propylene diene rubber may comprise a tensile elongation at break greater than or equal to 750% or even greater than or equal to 1000%. In embodiments, the ethylene alpha-olefin polyolefin elastomer and/or the ethylene propylene diene rubber may comprise a tensile elongation at break less than or equal to 1750% or even less than or equal to 1500%. In embodiments, the ethylene alpha-olefin polyolefin elastomer and/or the ethylene propylene diene rubber may comprise a tensile elongation at break from 750% to 1750%, from 750% to 1500%, from 1000% to 1750%, or even from 1000% to 1500%, or any and all sub-ranges formed from any of these endpoints.

In embodiments, the ethylene alpha-olefin polyolefin elastomer and/or the ethylene propylene diene rubber may comprise a Shore A hardness greater than or equal to 40 or even greater than or equal to 45. In embodiments, the ethylene alpha-olefin polyolefin elastomer and/or the ethylene propylene diene rubber may comprise a Shore A hardness less than or equal to 60 MPa or even less than or equal to 65 MPa. In embodiments, the ethylene alpha-olefin polyolefin elastomer and/or the ethylene propylene diene rubber may comprise a Shore A hardness from 40 to 60, from 40 to 55, from 45 to 60, or even from 45 to 55, or any and all sub-ranges formed from any of these endpoints.

Suitable commercial embodiments of the ethylene alpha-olefin polyolefin elastomer may include the ENGAGE brand from the Dow Chemical Company, such as grade XLT 8677. Similarly, the ethylene propylene diene rubber may be available under the NORDEL brand from Dow Chemical Company, such as grade IP 4785HM. Table 2 shows certain properties of ENGAGE XLT 8677 and NORDEL IP 4785HM.

TABLE 2

| | ENGAGE | NORDEL |
|---|---|---|
| | XLT 8677 | IP 4785HM |
| Melt flow rate (190° C./2.16 kg) (g/10 min) | 0.50 | — |
| Density (g/cm³) | 0.870 | 0.880 |
| Mooney viscosity (ML 1 + 4) | 45 (121° C.) | 85 (125° C.) |
| Tensile strength at break (MPa) | 3.00 | — |
| Tensile elongation at break (%) | >1000% | — |
| Shore A Hardness | 51 | — |

### Nitrile Butadiene Rubber

As described hereinabove, the presence and specific amount of nitrile butadiene rubber, along with thermoplastic polyolefin and at least one of ethylene alpha-olefin polyolefin elastomer and ethylene propylene diene rubber, produces a thermoset article having improved oil resistance.

In embodiments, the nitrile butadiene rubber is included in amounts greater than 20 wt %. In embodiments, the nitrile butadiene rubber may be limited (e.g., less than or equal to 60 wt %). In embodiments, the amount of nitrile butadiene rubber in the thermoset article may be greater than or equal to 20 wt %, greater than or equal to 25 wt %, greater than or equal to 30 wt %, greater than or equal to 33 wt %, greater than or equal to 35 wt %, greater than or equal to 37 wt %, or even greater than or equal to 39 wt %. In embodiments, the amount of nitrile butadiene rubber in the thermoset article may be less than or equal to 60 wt %, less than or equal to 57 wt %, less than or equal to 55 wt %, less than or equal to 53 wt %, or even less than or equal to 51 wt %. In embodiments, the amount of nitrile butadiene rubber in the thermoset article may be from 20 wt % to 60 wt %, from 20 wt % to 57 wt %, from 20 wt % to 55 wt %, from 20 wt % to 53 wt %, from 20 wt % to 51 wt %, from 25 wt % to 60 wt %, from 25 wt % to 57 wt %, from 25 wt % to 55 wt %, from 25 wt % to 53 wt %, from 25 wt % to 51 wt %, from 30 wt % to 60 wt %, from 30 wt % to 57 wt %, from 30 wt % to 55 wt %, from 30 wt % to 53 wt %, from 30 wt % to 51 wt %, from 33 wt % to 60 wt %, from 33 wt % to 57 wt %, from 33 wt % to 55 wt %, from 33 wt % to 53 wt %, from 33 wt % to 51 wt %, from 35 wt % to 60 wt %, from 35 wt % to 57 wt %, from 35 wt % to 55 wt %, from 35 wt % to 53 wt %, from 35 wt % to 51 wt %, from 37 wt % to 60 wt %, from 37 wt % to 57 wt %, from 37 wt % to 55 wt %, from 37 wt % to 53 wt %, from 37 wt % to 51 wt %, from 39 wt % to 60 wt %, from 39 wt % to 57 wt %, from 39 wt % to 55 wt %, from 39 wt % to 53 wt %, or even from 39 wt % to 51 wt %, or any and all sub-ranges formed from any of these endpoints.

In embodiments, the nitrile butadiene rubber may comprise a density greater than or equal to 0.95 g/cm³ or even greater than or equal to 1.00 g/cm³. In embodiments, the nitrile butadiene rubber may comprise a density less than or equal to 1.15 g/cm³ or even less than or equal to 1.10 g/cm³. In embodiments, the nitrile butadiene rubber may comprise a density from 0.95 g/cm³ to 1.15 g/cm³, from 0.95 g/cm³ to 1.10 g/cm³, from 1.00 g/cm³ to 1.15 g/cm³, or even from 1.00 g/cm³ to 1.10 g/cm³, or any and all sub-ranges formed from any of these endpoints.

In embodiments, the nitrile butadiene rubber may comprise a Mooney viscosity (M+L, 100° C.) greater than or equal to 35 or even greater than or equal to 45. In embodiments, the nitrile butadiene rubber may comprise a Mooney viscosity (M+L, 100° C.) less than or equal to 65 or even less than or equal to 55. In embodiments, the nitrile butadiene rubber may comprise a Mooney viscosity (M+L, 100° C.) from 35 to 65, from 35 to 55, from 45 to 65, or even from 45 to 55, or any and all sub-ranges formed from any of these endpoints.

In embodiments, the nitrile butadiene rubber may comprise an acrylonitrile content greater than or equal to 25 wt % or even greater than or equal to 30 wt %. In embodiments, the nitrile butadiene rubber may comprise an acrylonitrile content less than or equal to 40 wt % or even less or equal to 35 wt %. In embodiments, the nitrile butadiene rubber may comprise an acrylonitrile content from 25 wt % to 40 wt %, from 25 wt % to 35 wt %, from 30 wt % to 40 wt %, from 30 wt % to 35 wt %, or any and all sub-ranges formed from any of these endpoints.

Suitable commercial embodiments of the nitrile butadiene rubber are available under the CHEMIGUM brand from Synthomer, such as grade P615DS. Table 3 shows certain properties of CHEMIGUM P615DS.

TABLE 3

| | CHEMIGUM P615DS |
|---|---|
| Density (g/cm³) | 1.04 |
| Mooney viscosity (ML 1 + 4, 100° C.) | 50 |
| acrylonitrile content (%) | 33 |

### Silane

As stated hereinabove, at least one of the thermoplastic polyolefin, the at least one of the ethylene alpha-olefin polyolefin elastomer and the ethylene propylene diene rubber, and the nitrile butadiene rubber is silane grafted and silane crosslinked. The occurrence of silane crosslinking results in a thermoset article having improved oil resistance.

Various silanes are considered suitable for the present thermoset articles. In embodiments, the silane may comprise vinyl trialkoxysilane. For example, in embodiments, the silane may comprise vinyl trimethoxysilane, vinyl triethoxysilane, or a combination thereof.

In embodiments, the silane is included in amounts greater than or equal to 0.5 wt % such that at least one of the thermoplastic polyolefin, the at least one of the ethylene alpha-olefin polyolefin elastomer and the ethylene propylene diene rubber, and the nitrile butadiene rubber is silane grafted and silane crosslinked to produce a thermoset article having improved oil resistance. In embodiments, the amount of silane in the thermoset article may be greater than or equal to 0.5 wt %, greater than or equal to 1 wt %, or even greater than or equal to 2 wt %. In embodiments, the amount of silane in the thermoset article may be less than or equal to 5 wt % or even less than or equal to 3 wt %. In embodiments, the amount of silane in the thermoset article may be from 0.5 wt % to 5 wt %, from 0.5 wt % to 3 wt %, from 1 wt %, to 5 wt %, from 1 wt % to 3 wt %, from 2 wt % to 5 wt %, or even from 2 wt % to 3 wt %, or any and all sub-ranges formed from any of these endpoints.

In embodiments, the silane may have a specific gravity greater than or equal to 0.9 or even greater than or equal to 0.95. In embodiments, the silane may have a specific gravity less than or equal to 1.05 or even less than or equal to 1. In embodiments, the silane may have a specific gravity from 0.9 to 1.05, from 0.9 to 1, from 0.95 to 1.05, or even from 0.95 to 1, or any and all sub-ranges formed from any of these endpoints.

In embodiments, the silane may have a boiling point greater than or equal to 75° C. or even greater than or equal to 100° C. In embodiments, the silane may have a boiling point less than or equal to 150° C. or even less than or equal to 125° C. In embodiments, the silane may have a boiling point from 75° C. to 150° C., from 75° C. to 125° C., from 100° C. to 150° C., or even from 100° C. to 125° C., or any and all sub-ranges formed from any of these endpoints.

Suitable commercial embodiments of the silane are available under the SILQUEST brand from Momentive, such as grade A-171.

In embodiments, the silane may be included in a solution comprising organic peroxide such that the silane is better dispersed within the thermoplastic polyolefin, the at least one of the ethylene alpha-olefin polyolefin elastomer and the ethylene propylene diene rubber, and/or the nitrile butadiene rubber, leading to improved silane grafting and silane crosslinking. In embodiments, the organic peroxide may comprise dicumyl peroxide. In embodiments, the amount of organic peroxide in the thermoset article may be greater than or equal to 0.05 wt % or even greater than or equal to 0.1 wt %. In embodiments, the amount of organic peroxide in the thermoset article may be less than or equal to 1 wt % or even less than or equal to 0.5 wt %. In embodiments, the amount of organic peroxide in the thermoset article may be from 0.05 wt % to 1 wt %, from 0.05 wt % to 0.5 wt %, from 0.1 wt % to 1 wt %, or even from 0.1 wt % to 0.5 wt %, or any and all sub-ranges formed from any of these endpoints.

In embodiments, the organic peroxide may have a density greater than or equal to 1.00 g/cm³ or even greater than or equal to 1.05 g/cm³. In embodiments, the organic peroxide may have a density less than or equal to 1.20 g/cm³ or even less than or equal to 1.15 g/cm³. In embodiments, the organic peroxide may have a density from 1.00 g/cm³ to 1.20 g/cm³, from 1.00 g/cm³ to 1.15 g/cm³, from 1.05 g/cm³ to 1.20 g/cm³, or even from 1.05 g/cm³ to 1.15 g/cm³, or any and all sub-ranges formed from any of these endpoints.

In embodiments, the organic peroxide may have a boiling point greater than or equal to 75° C. or even greater than or equal to 100° C. In embodiments, the organic peroxide may have a boiling point less than or equal to 150° C. or even less than or equal to 125° C. In embodiments, the organic peroxide may have a boiling point from 75° C. to 150° C., from 75° C. to 125° C., from 100° C. to 150° C., or even from 100° C. to 125° C., or any and all sub-ranges formed from any of these endpoints. In embodiments, the organic peroxide may decompose at a temperature lower than the boiling point of the organic peroxide.

Suitable commercial embodiments of the organic peroxide are available under the PERKADOX brand from AkzoNobel, such as grade BC-FF.

### Thermoset Article

As described herein, the occurrence of silane crosslinking, along with the specific amounts of thermoplastic polyolefin, at least one of the ethylene alpha-olefin polyolefin elastomer and ethylene propylene diene rubber, and nitrile butadiene rubber, produces a thermoset article having improved oil resistance.

In embodiments, at least one of the thermoplastic polyolefin, the ethylene alpha-olefin polyolefin elastomer, the ethylene propylene diene rubber, and the nitrile butadiene rubber may be silane grafted and silane crosslinked. In embodiments, the at least one of the ethylene alpha-olefin polyolefin elastomer and the ethylene propylene diene rubber and the nitrile butadiene rubber may be silane crosslinked.

In embodiments, the silane crosslinking is at least one of intramolecular silane crosslinking and intermolecular silane crosslinking. For example, in embodiments, at least one of the ethylene alpha-olefin polyolefin elastomer and the ethylene propylene diene rubber may be silane crosslinked to the nitrile butadiene rubber.

In embodiment, the thermoset article may comprise a thermoplastic polyolefin phase comprising the thermoplastic polyolefin and a rubber phase comprising the at least one of the ethylene alpha-olefin polyolefin elastomer and the ethylene propylene diene rubber and the nitrile butadiene rubber. In embodiments, the amount of the rubber phase (i.e., amount of the at least one of the ethylene alpha-olefin polyolefin elastomer and the ethylene propylene diene rubber+the amount of the nitrile butadiene rubber) in the thermoset article may be greater than or equal to 60 wt %, greater than or equal to 65 wt %, or even greater than or equal to 70 wt %. In embodiments, the amount of the rubber phase in the thermoset article may be less than or equal to 90 wt %, less than or equal to 85 wt %, or even less than or equal to 80 wt %. In embodiments, the amount of the rubber phase in the thermoset article may be from 60 wt % to 90 wt %, from 60 wt % to 85 wt %, from 60 wt % to 80 wt %, from 65 wt % to 90 wt %, from 65 wt % to 85 wt %, from 65 wt % to 80 wt %, from 70 wt % to 90 wt %, from 70 wt % to 85 wt %, or even from 70 wt % to 80 wt %, or any and all sub-ranges formed from any of these endpoints.

In embodiments, the thermoset article may have a Shore A hardness greater than or equal to 50, greater than or equal to 60, greater than or equal to 75, or even greater than or equal to 80. In embodiments, the thermoset article may have a Shore A hardness less than or equal to 95 or even less than or equal to 90. In embodiments, the thermoset article may have a Shore A hardness from 50 to 95, from 50 to 90, from 60 to 95, from 60 to 90, from 70 to 95, from 70 to 90, from 75 to 95, from 75 to 90, from 80 to 95, or even from 80 to 90, or any and all sub-ranges formed from any of these endpoints.

In embodiments, the thermoset article may have a tensile strength at break greater than or equal to 5 MPa, greater than or equal to 6 MPa, or even greater than or equal to 7 MPa. In embodiments, the thermoset article may have a tensile strength at break less than or equal to 12 MPa, less than or equal to 11 MPa, or even less than or equal to 10 MPa. In embodiments, the thermoset article may have a tensile strength at break from 5 MPa to 12 MPa, from 5 MPa to 11 MPa, from 5 MPa to 10 MPa, from 6 MPa to 12 MPa, from 6 MPa to 11 MPa, from 6 MPa to 10 MPa, from 7 MPa to 12 MPa, from 7 MPa to 11 MPa, or even from 7 MPa to 10 MPa, or any and all sub-ranges formed from any of these endpoints.

In embodiments, the thermoset article may have a tensile elongation at break greater than or equal to 75%, greater than or equal to 100%, greater than or equal to 125%, or even greater than or equal to 150%. In embodiments, the thermoset article may have a tensile elongation at break less than or equal to 325%, less than or equal to 300%, less than or equal to 275%, or even less than or equal to 250%. In embodiments, the thermoset article may have a tensile elongation at break from 75% to 325%, from 75% to 300%, from 75% to 275%, from 75% to 250%, from 100% to 325%, from 100% to 300%, from 100% to 275%, from 100% to 250%, from 125% to 325%, from 125% to 300%, from 125% to 275%, from 125% to 250%, from 150% to 325%, from 150% to 300%, from 150% to 275%, or even from 150% to 250%, or any and all sub-ranges formed from any of these endpoints.

In embodiments, the thermoset article may include a thermoplastic polyolefin comprising polypropylene homopolymer; 25 wt % to 43 wt % of the ethylene alpha-olefin polyolefin elastomer, the ethylene alpha-olefin polyolefin elastomer comprising ethylene-octene copolymer; and 37 wt % to 53 wt % of nitrile butadiene rubber.

As exemplified in the Examples section below, the thermoset articles described herein comprising a crosslinked reaction product of thermoplastic polyolefin, at least one of ethylene alpha-olefin polyolefin elastomer and ethylene propylene diene rubber, nitrile butadiene rubber, and silane have improved oil resistance.

### Moisture Cure Catalyst

In embodiments, the thermoset article may comprise a moisture cure catalyst to initiate silane crosslinking of at least one of the thermoplastic polyolefin, the at least one of the ethylene alpha-olefin polyolefin elastomer and the ethylene propylene diene rubber, and the nitrile butadiene rubber.

In embodiments, the moisture cure catalyst may comprise organotin (e.g., dibutalin dilaurate), carboxylic acids, metal complex compounds (e.g., metal carboxylates), aluminum triacetyl acetonate, nickel tetraacetyl acetonate, chromium hexaacetyl acetonate, titanium tetraacetyl acetonate, and metal alkoxides (e.g., aluminum ethoxide, aluminum propoxide, titanium ethoxide, titanium propoxide), or a combination thereof.

In embodiments, the catalyst is blended with the thermoplastic polyolefin, the at least one of the ethylene alpha-olefin polyolefin elastomer and the ethylene propylene diene rubber, the nitrile butadiene rubber, and the silane during silane grafting. In other embodiments, the catalyst is added to the extruded or molded formulation wherein at least one of the thermoplastic polyolefin, the at least one of the ethylene alpha-olefin polyolefin elastomer and the ethylene propylene diene rubber, and the nitrile butadiene rubber is silane grafted. The at least one of the thermoplastic polyolefin, the at least one of the ethylene alpha-olefin polyolefin elastomer and the ethylene propylene diene rubber, and the nitrile butadiene rubber that is silane grafted will crosslink upon exposure to moisture (e.g., air).

### Compatibilizer

In embodiments, the thermoset articles described herein may further comprise compatibilizer. The compatibilizer may react or be compatible with the thermoplastic polyolefin, the ethylene alpha-olefin polyolefin elastomer, the ethylene propylene diene rubber, and the nitrile butadiene rubber to alter the dissimilar phases and improve the compatibility of the thermoset article.

In embodiments, the compatibilizer may comprise a copolymer of ethylene and a polar comonomer, such as ethylene-vinyl acetate.

In embodiments, the amount of compatibilizer in the thermoset article may be greater than or equal to 2 wt %, greater than or equal to 4 wt %, or even greater than or equal to 6 wt %. In embodiments, the amount of compatibilizer in the thermoset article may be less than or equal to 20 wt %, less than or equal to 15 wt %, or even less than or equal to 10 wt %. In embodiments, the amount of compatibilizer in the thermoset article may be from 2 wt % to 20 wt %, from 2 wt % to 15 wt %, from 2 wt % to 10 wt %, from 4 wt % to 20 wt %, from 4 wt % to 15 wt %, from 4 wt % to 10 wt %, from 6 wt % to 20 wt %, from 6 wt % to 15 wt %, or even from 6 wt % to 10 wt %, or any and all sub-ranges formed from any of these endpoints.

Suitable commercial embodiments of the compatibilizer are available under the ELVAX brand from Dow Chemical Company, such as grade 265.

### Plasticizer

In embodiments, the thermoset articles described herein may further comprise plasticizer to reduce hardness and improve flow.

In embodiments, the plasticizer may comprise polar plasticizer (e.g. dibutoxyethoxyethyl adipate), non-polar plasticizer (e.g., mineral oil), or a combination thereof.

In embodiments, the amount of plasticizer in the thermoset article may be greater than or equal to 1 wt %, or even greater than or equal to 1.5 wt %. In embodiments, the amount of plasticizer in the thermoset article may be less than or equal to 20 wt %, less than or equal to 10 wt %, or even less than or equal to 5 wt %. In embodiments, the amount of plasticizer in the thermoset article may be from 1 wt % to 20 wt %, from 1 wt % to 10 wt %, from 1 wt % to 5 wt %, from 1.5 wt % to 20 wt %, from 1.5 wt % to 10 wt %, or even from 1.5 wt % to 5 wt %, or any and all sub-ranges formed from any of these endpoints.

Suitable commercial embodiments of the plasticizer are available under the TP brand from Hallstar, such as grade 95.

### Additives

In embodiments, the thermoset article may further comprise an additive. In embodiments, the additive may comprise adhesion promoters; biocides; anti-fogging agents; anti-static agents; blowing and foaming agents; bonding agents and bonding polymers; polar copolymers (e.g., ethylene-vinyl acetate (EVA), ethylene butyl acrylate (EBA), or ethyl methacrylate (EMA)); dispersants; flame retardants and smoke suppressants; mineral fillers; initiators; lubricants; micas; pigments, colorants, and dyes; processing aids; release agents; silanes, titanates, and zirconates; slip and anti-blocking agents; stearates; ultraviolet light absorbers; viscosity regulators; waxes; or combinations thereof.

### Processing

In embodiments, the thermoset article described herein may be made with a batch process or continuous process.

In embodiments, the components of the thermoset article, including: the thermoplastic polyolefin; at least one of the ethylene alpha-olefin polyolefin elastomer and the ethylene propylene diene rubber; and the nitrile butadiene rubber may be added to an extruder (27 MM Leistriz Twin Extruder (L/D 52)) and blended. In embodiments, silane is added to the blend such that at least one of the thermoplastic polyolefin, the ethylene alpha-olefin polyolefin elastomer, the ethylene propylene diene rubber, and the nitrile butadiene rubber is silane grafted. In embodiments, the blending (e.g., in the barrel of the extruder) may be carried out at a temperature from 150° C. to 220° C.

Blending (also known as compounding) devices are well known to those skilled in the art and generally include feed means, especially at least one hopper for pulverulent materials and/or at least one injection pump for liquid materials; high-shear blending means, for example a co-rotating or counter-rotating twin-screw extruder, usually comprising a feed screw placed in a heated barrel (or tube); an output head, which gives the extrudate its shape; and means for cooling the extrudate, either by air cooling or by circulation of water. The extrudate is generally in the form of rods continuously exiting the device and able to be cut or formed into granules. However, other forms may be obtained by fitting a die of desired shape on the output die.

In embodiments, the shaped, silane-grafted blend may be cured such that at least one of the thermoplastic polyolefin, the ethylene alpha-olefin polyolefin elastomer, the ethylene propylene diene rubber, and the nitrile butadiene rubber is silane crosslinked. In embodiments, a moisture cure catalyst may be added to initiate silane crosslinking of at least one of the thermoplastic polyolefin, the ethylene alpha-olefin polyolefin elastomer, the ethylene propylene diene rubber, and the nitrile butadiene rubber. In embodiments, the catalyst is blended with: the thermoplastic polyolefin; the at least one of the ethylene alpha-olefin polyolefin elastomer and the ethylene propylene diene rubber; the nitrile butadiene rubber; and the silane during silane grafting. In other embodiments, the catalyst is added at the extrusion step.

### EXAMPLES

Table 4 below shows sources of ingredients for the formulations used to form the thermoset articles of Comparative Examples C1 and C2 and Examples E1-E9.

TABLE 4

| Ingredients | Brand | Source |
|---|---|---|
| Thermoplastic Polyolefin | FORMOLENE | Formosa |
| (polypropylene hompolymer) | 1102KR | Plastics |
| Ethylene alpha-olefin polyolefin | ENGAGE | Dow Chemical |
| elastomer (ethylene-octene copolymer) | XLT 8677 | Company |
| nitrile butadiene rubber | CHEMIGUM | Synthomer |
| | P615DS | |
| ethylene-vinyl acetate | ELVAX 265 | Dow Chemical |
| (compatibilizer) | | Company |
| dibutoxyethoxyethyl adipate | TP-95 | Hallstar |
| (plasticizer) | | |
| vinyltrimethoxy silane | SILQUEST | Momentive |
| | A-171 | |
| dicumyl peroxide | PERKADOX | AkzoNobel |
| | BC-FF | |

Table 5 below shows the formulations used to form and the certain properties of Comparative Examples C1 and C2 and Examples E1 to E9. To prepare the comparative and exemplary thermoset plaques, the components of the formulations listed in Table 5 were added into a 27 MM Leistriz Twin Extruder (L/D 52) and blended at a barrel temperature of 193° C. and a rate of 5 rotations per second. The mixed formulation was extruded at a speed of 5 g/s. The extruded formulation was blended with 3% tin catalyst master match (MB). MB has a polyether carrier with 1.5% dibutylin dilaurate (MARK 1038, Galata Chemicals). The blended formulation was injection molded (i.e., shaped) to form a plaque. The plaque was conditioned at 90° C. and 90% relative humidity for 24 hours prior to measuring the properties listed in Table 5.

To measure the “oil immersion weight increase” listed in Table 5, the plaque having a diameter of 39 mm and a thickness of 3 mm was weighed and then immersed in IRM 903 oil for 3 days at 125° C. After immersion, the plaque was weighed and the weight percentage increase was calculated.

TABLE 5

| | Example | | | | | |
|---|---|---|---|---|---|---|
| | C1 | | C2 | | E1 | |
| Ingredient | Parts | Wt. % | Parts | Wt. % | Parts | Wt. % |
| FORMOLENE 1102KR | 12.00 | 12.06 | 19.00 | 19.10 | 12.00 | 7.18 |
| ENGAGE XLT 8677 | 60.00 | 60.31 | 78.00 | 78.40 | 60.00 | 35.89 |
| CHEMIGUM P615DS | 0 | 0 | 0 | 0 | 66.00 | 39.48 |
| ELVAX 265 | 25.00 | 25.13 | 0 | 0 | 25.00 | 14.95 |
| SILQUEST A-171 | 2.31 | 2.32 | 2.31 | 2.32 | 3.87 | 2.32 |
| PERKADOX BC-FF | 0.18 | 0.18 | 0.18 | 0.18 | 0.30 | 0.18 |
| TOTAL | 99.49 | 100.00 | 99.49 | 100.00 | 167.17 | 100.00 |
| Hardness (Shore A) | 83 | | 87 | | 76 | |
| Tensile strength | 9.2 | | 9.6 | | 6.3 | |
| at break (MPa) | | | | | | |
| Tensile elongation | 150 | | 160 | | 150 | |
| at break (%) | | | | | | |
| Oil immersion weight | 225 | | 212 | | 135 | |
| increase (125° C./ | | | | | | |
| 3 days, %) | | | | | | |
| | Example | | | | | |
| | E2 | | E3 | | E4 | |
| Ingredient | Parts | Wt. % | Parts | Wt. % | Parts | Wt. % |
| FORMOLENE 1102KR | 24.00 | 14.36 | 17.00 | 10.17 | 28.00 | 16.75 |
| ENGAGE XLT 8677 | 48.00 | 28.71 | 68.00 | 40.68 | 57.00 | 34.10 |
| CHEMIGUM P615DS | 66.00 | 39.48 | 66.00 | 39.48 | 66.00 | 39.48 |
| ELVAX 265 | 25.00 | 14.95 | 12.00 | 7.18 | 12.00 | 7.18 |
| SILQUEST A-171 | 3.87 | 2.32 | 3.87 | 2.32 | 3.87 | 2.32 |
| PERKADOX BC-FF | 0.30 | 0.18 | 0.30 | 0.18 | 0.30 | 0.18 |
| TOTAL | 167.17 | 100.00 | 167.17 | 100.00 | 167.17 | 100.00 |
| Hardness (Shore A) | 86 | | 79 | | 88 | |
| Tensile strength | 8.8 | | 5.4 | | 9.5 | |
| at break (MPa) | | | | | | |
| Tensile elongation | 220 | | 100 | | 205 | |
| at break (%) | | | | | | |
| Oil immersion weight | 125 | | 131 | | 115 | |
| increase (125° C./ | | | | | | |
| 3 days, %) | | | | | | |
| | Example | | | | | |
| | E5 | | E6 | | E7 | |
| Ingredient | Parts | Wt. % | Parts | Wt. % | Parts | Wt. % |
| FORMOLENE 1102KR | 28.00 | 13.72 | 30.00 | 18.04 | 30.00 | 17.95 |
| ENGAGE XLT 8677 | 57.00 | 27.93 | 52.00 | 31.26 | 52.00 | 31.11 |
| CHEMIGUM P615DS | 102.00 | 49.98 | 62.70 | 37.70 | 62.70 | 37.51 |
| ELVAX 265 | 12.00 | 5.88 | 15.00 | 9.02 | 15.00 | 8.97 |
| TP-95 | 0 | 0 | 3.30 | 1.98 | 3.30 | 1.97 |
| SILQUEST A-171 | 4.74 | 2.32 | 3.08 | 1.85 | 3.87 | 2.32 |
| PERKADOX BC-FF | 0.36 | 0.18 | 0.25 | 0.15 | 0.3 | 0.18 |
| TOTAL | 204.1 | 100.00 | 166.33 | 100.00 | 167.17 | 100.00 |
| Hardness (Shore A) | 87 | | 88 | | 88 | |
| Tensile strength | 6.8 | | 10.7 | | 10.0 | |
| at break (MPa) | | | | | | |
| Tensile elongation | 100 | | 300 | | 260 | |
| at break (%) | | | | | | |
| Oil immersion weight | 102 | | 130 | | 123 | |
| increase (125° C./ | | | | | | |
| 3 days, %) | | | | | | |

| | Example | | | |
|---|---|---|---|---|
| | E8 | | E9 | |
| Ingredient | Parts | Wt. % | Parts | Wt. % |
| FORMOLENE 1102KR | 30.00 | 14.85 | 30.00 | 14.92 |
| ENGAGE XLT 8677 | 52.00 | 25.74 | 52.00 | 25.87 |
| CHEMIGUM P615DS | 95.00 | 47.02 | 95.00 | 47.26 |
| ELVAX 265 | 15.00 | 7.42 | 15.00 | 7.46 |
| TP-95 | 5.00 | 2.47 | 5.00 | 2.49 |
| SILQUEST A-171 | 4.68 | 2.32 | 3.72 | 1.85 |
| PERKADOX BC-FF | 0.37 | 0.18 | 0.3 | 0.15 |
| TOTAL | 202.05 | 100.00 | 201.02 | 100.00 |
| Hardness (Shore A) | 85 | | 85 | |
| Tensile strength | 7.5 | | 7.7 | |
| at break (MPa) | | | | |
| Tensile elongation | 130 | | 150 | |
| at break (%) | | | | |
| Oil immersion weight | 104 | | 110 | |
| increase (125° C./ | | | | |
| 3 days, %) | | | | |

As shown in Table 5, Examples E1-E9, thermoset articles including thermoplastic polyolefin (FORMOLENE 1102KR), ethylene alpha-olefin polyolefin elastomer (ENGAGE XLT 8677), and nitrile butadiene rubber (CHEMIGUM P615D), showed a reduced oil immersion weight increase as compared to Comparative Examples C1 and C2, thermoset articles including FORMOLENE 1102KR and ENGAGE XLT 8677 without CHEMIGUM P615D, which had an oil immersion weight increase of 225% and 212%, respectively. As indicated by Comparative Examples C1 and C2 and Examples E1-E9, including nitrile butadiene rubber with thermoplastic polyolefin and ethylene alpha-olefin polyolefin elastomer results in an oil resistant thermoset article as compared to a thermoset article that does not include nitrile butadiene rubber.

It will be apparent that modifications and variations are possible without departing from the scope of the disclosure defined in the appended claims. More specifically, although some aspects of the present disclosure are identified herein as preferred or particularly advantageous, it is contemplated that the present disclosure is not necessarily limited to these aspects.

What is claimed is:

1. A thermoset article comprising a crosslinked reaction product of:
thermoplastic polyolefin;
at least one of ethylene alpha-olefin polyolefin elastomer and ethylene propylene diene rubber;
nitrile butadiene rubber; and
silane;
wherein at least one of the thermoplastic polyolefin, the at least one of the ethylene alpha-olefin polyolefin elastomer and the ethylene propylene diene rubber, and the nitrile butadiene rubber is silane grafted and silane crosslinked, and
wherein the silane crosslinking is at least one of intramolecular silane crosslinking and intermolecular silane crosslinking.

2. The thermoset article of claim 1, wherein the thermoset article comprises:
a thermoplastic polyolefin phase comprising the thermoplastic polyolefin; and
a rubber phase comprising the at least one of ethylene alpha-olefin polyolefin elastomer and the ethylene propylene diene rubber and the nitrile butadiene rubber.

3. The thermoset article of claim 1, wherein the at least one of ethylene alpha-olefin polyolefin elastomer and the ethylene propylene diene rubber and the nitrile butadiene rubber are silane crosslinked.

4. The thermoset article of claim 3, wherein the at least one of ethylene alpha-olefin polyolefin elastomer and the ethylene propylene diene rubber is silane crosslinked to the nitrile butadiene rubber.

5. The thermoset article of claim 1, wherein the thermoset article comprises 5 wt % to 20 wt % of the thermoplastic polyolefin.

6. The thermoset article of claim 1, wherein the thermoplastic polyolefin comprises polypropylene, polyethylene, or a combination thereof.

7. The thermoset article of claim 1, wherein the thermoplastic polyolefin comprises polypropylene homopolymer.

8. The thermoset article of claim 1, wherein the thermoset article comprises 20 wt % to 70 wt % of the at least one of the ethylene alpha-olefin polyolefin elastomer and the ethylene propylene diene rubber.

9-10. (canceled)

11. The thermoset article of claim 1, wherein the thermoset article comprises 20 wt % to 60 wt % of the nitrile butadiene rubber.

12. The thermoset article of claim 1, wherein the thermoset article comprises 0.5 wt % to 5 wt % silane.

13-16. (canceled)

17. The thermoset article of claim 1, wherein the thermoset article further comprises a moisture cure catalyst.

18. The thermoset article of claim 17, wherein the moisture cure catalyst comprises organotin, carboxylic acids, metal complex compounds, aluminum triacetyl acetonate, nickel tetraacetyl acetonate, chromium hexaacetyl acetonate, titanium tetraacetyl acetonate, and metal alkoxides, or a combination thereof.

19. The thermoset article of claim 1, wherein the thermoset article further comprises compatibilizer.

20. The thermoset article of claim 19, wherein the thermoset article comprises 2 wt % to 20 wt % of the compatibilizer.

21. The thermoset article of claim 19, wherein the compatibilizer comprises ethylene-vinyl acetate.

22. The thermoset article of claim 1, wherein the thermoset article further comprises plasticizer.

23-24. (canceled)

25. The thermoset article of claim 1, wherein:
the thermoplastic polyolefin comprises polypropylene homopolymer; and
the thermoset article comprises:
25 wt % to 43 wt % of the ethylene alpha-olefin polyolefin elastomer, the ethylene alpha-olefin polyolefin elastomer comprising ethylene-octene copolymer; and
37 wt % to 53 wt % of the nitrile butadiene rubber.

26. A process for making a thermoset article comprising a crosslinked reaction product of thermoplastic polyolefin, at least one of ethylene alpha-olefin polyolefin elastomer and ethylene propylene diene rubber, nitrile butadiene rubber, and silane, the process comprising the steps of:
blending the thermoplastic polyolefin, the at least one of the ethylene alpha-olefin polyolefin elastomer and the ethylene propylene diene rubber, and the nitrile butadiene rubber;
grafting the blend with silane such that at least one of the thermoplastic polyolefin, the at least one of ethylene alpha-olefin polyolefin elastomer and the ethylene propylene diene rubber, and the nitrile butadiene rubber is silane grafted;
shaping the silane-grafted blend; and
curing the shaped, silane-grafted blend such that at least one of the thermoplastic polyolefin, the at least one of the ethylene alpha-olefin polyolefin elastomer and the ethylene propylene diene rubber, and the nitrile butadiene rubber is silane crosslinked.

27. The process of claim 26, wherein the silane is included in a solution comprising organic peroxide.

28. The process of claim 26, wherein the process further includes adding a moisture cure catalyst, the moisture cure catalyst comprising organotin, carboxylic acids, metal complex compounds, aluminum triacetyl acetonate, nickel tetraacetyl acetonate, chromium hexaacetyl acetonate, titanium tetraacetyl acetonate, and metal alkoxides.
